(19) United States
(12) Patent Application Publication
(10) Pub. No.: US 2016/0014371 A1
(43) Pub. Date: Jan. 14, 2016

(54) SOCIAL TELEVISION TELEPRESENCE SYSTEM AND METHOD

(71) Applicants: Mark J. HUBER, Burbank, CA (US); Mark Leroy WALKER, Castaic, CA (US); William Gibbens REDMANN, Glendale, CA (US); THOMSON LICENSING, Issy Les Moulineaux (FR)

(72) Inventors: Mark J. HUBER, Burbank, CA (US); Mark Leroy WALKER, Castaic, CA (US); William Gibbens REDMANN, Glendale, CA (US)

(21) Appl. No.: 14/770,324

(22) PCT Filed: Apr. 24, 2013
(86) PCT No.: PCT/US2013/037955

§ 371 Date: Aug. 25, 2015

(51) Int. Cl. H04N 7/14; H04N 21/4788; H04N 7/15

(52) U.S. Cl. CPC H04N 7/144; H04N 7/15; H04N 21/4788

(57) ABSTRACT

Management of received images of remote participants displayed to a local participant in a telepresence system commences by first establishing the orientations of the remote telepresence system participants relative to their respective image capture devices (telepresence cameras). The received images of the remote participant(s) undergo processing for display to the local participant in accordance with the established orientations to control at least one of image visibility and image location within the displayed image observed by the local participant.

### BACKGROUND ART

Traditional videoconference systems display images on individual monitors or individual windows on a single monitor. Each monitor or each window of the single monitor displays an image provided by a corresponding video camera at a particular location. In addition to the video camera image(s), one or more locations can contribute a shared presentation (e.g., Microsoft PowerPoint® slides or the like) for display on a separate monitor or window. In the past, such videoconference systems displayed the shared presentation on a main screen, with the image(s) of participant(s) displayed either on separate screens (allowing the presentation to fill the main screen), or in window(s) surrounding a less-than-full-screen display of the presentation. Alternatively, the windows may overlap or be hidden by a full-screen presentation of the shared presentation.

Typical video conference systems can easily generate the resulting display, but most participants often find that the resultant display appears unnatural and makes poor use of screen space (already in short supply, particularly if a single monitor must serve multiple purposes). Moreover, in traditional video conference systems, the remote participants, for the most part, face their respective camera, giving the appearance that they always look directly at the viewer who often observes an aesthetically unappealing image.

Various proposals exist to extend teleconferencing to subscribers of shared content delivery networks, such as those networks maintained by cable television companies and telecommunications carriers, to allow subscribers to share content as well as images of each other. Systems, which allow both image and content sharing, often bear the designation “telepresence systems.” Examples of such telepresence systems appear in applicants' co-pending applications PCT/US11/063036, PCT/US12/050130, PCT/US12/035749, and PCT/US13/24614, (all incorporated by reference herein). As described in these co-pending applications, a typical telepresence system includes a plurality of telepresence stations, each associated with a particular subscriber in communication with other subscribers at their respective telepresence stations. Each telepresence station typically has a monitor, referred to as a “telepresence” monitor for displaying the image of one or more “remote” participants, e.g., participants at remote stations whose images undergo captured by the cameras (the “telepresence” camera) at each participant's station. For ease of discussion, the term “local participant” refers to the participant whose image undergoes capture by the telepresence camera at that participant's station for display at one or more distant (e.g., “remote”) stations. Conversely, the term “remote participant” refers to a participant associated with a remote station whose image undergoes display for observation by a local participant.

In the case of a remote telepresence station whose telepresence monitor and camera lie to one side of the monitor showing shared content (e.g., the “shared content” monitor), the transmitted image of the remote participant will appear in profile to the local participant while the remote participant watches his or her content monitor. However, when that remote participant turns to face his or her telepresence monitor directly, that remote participant now appears to directly face the local participant. Thus, at any given time, some participants will directly face their corresponding telepresence cameras while others will not, giving rise to uncertainty as to how to manage the participants' images for display on the telepresence monitor at each telepresence station.

Thus, a need exists for a technique for managing the images of remote participants in a telepresence system.

### BRIEF SUMMARY OF THE INVENTION

Briefly, in accordance with a preferred embodiment of the present principles, a method for managing received images of remote participants displayed to a local participant in a telepresence system commences by first establishing for each remote telepresence station the relative orientation of the corresponding shared content screen and telepresence camera, with respect to the corresponding remote telepresence system participant (e.g., whether the camera is to the left, right, or substantially coincident with the shared content screen, from the vantage of the remote participant). The received images of the remote participant(s) undergo processing for display to the local participant in accordance with the established orientations to control at least one of image visibility and image location within the displayed image observed by the local participant.

### BRIEF DESCRIPTION OF THE DRAWINGS

FIG. 1 depicts is a block schematic diagram of an exemplary telepresence system having three telepresence stations, wherein one station uses the same monitor for shared content and telepresence images;

FIG. 2A depicts an exemplary presentation of telepresence images of the telepresence system of FIG. 1 overlaid onto shared content in a common window;

FIG. 2B depicts an exemplary treatment of a telepresence image of a remote participant not facing his or her telepresence camera;

FIG. 2C depicts another exemplary treatment a telepresence image of a remote participant not facing his or her telepresence camera;

FIG. 2D depicts another exemplary presentation of telepresence images of remote participants overlaid onto shared content in a common window;

FIG. 2E depicts an exemplary presentation of telepresence images of remote participants tiered and overlaid onto the shared content in a common window;

FIG. 3 depicts exemplary local telepresence images and remote telepresence images associated with a separate one of the telepresence stations of the telepresence system of FIG. 1 during its operation.

FIG. 4 depicts an exemplary calibration sequence performed by local participant to calibrate his or her telepresence image;

FIG. 5 depicts, in flowchart form, the steps of an exemplary process for exchanging and displaying telepresence images performed a telepresence station of the telepresence system of FIG. 1;

FIG. 6 depicts, in flowchart form, the steps of another exemplary process of exchanging and displaying telepresence images performed at a telepresence station of the telepresence system of FIG. 1; and,

FIG. 7 depicts a block diagram of a set top box for use at a local station of the telepresence system of FIG. 1 in accordance with the present principles.

### DETAILED DESCRIPTION

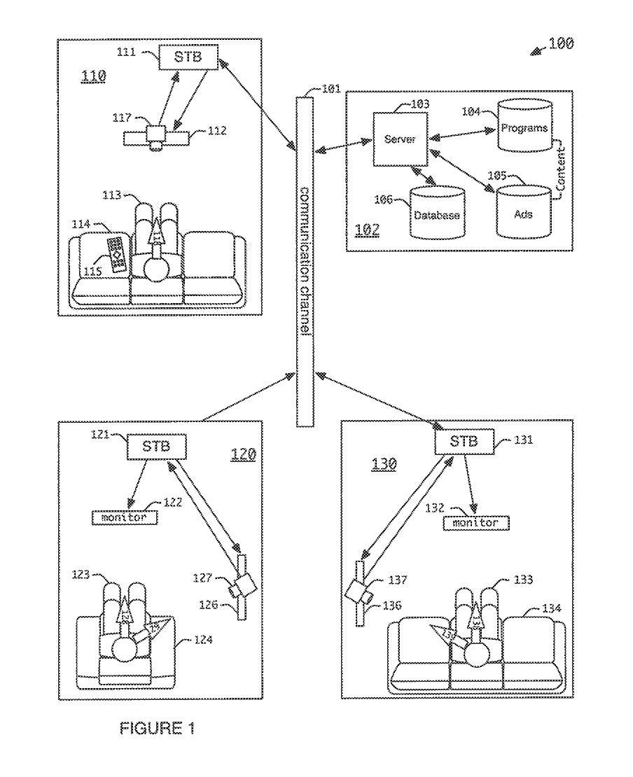

FIG. 1 depicts a telepresence system 100 having three telepresence stations 110, 120, and 130 at corresponding locations that could comprise residential or commercial premises. Each of the telepresence stations serves a corresponding one of participant 113, 123, and 133, respectively, (also called users, viewers, or audience members). At each of the telepresence stations 110, 120 and 130, each of the participants 113, 123 and 133, respectively, watches shared content on a corresponding one of shared content monitor 112, 122, and 132, respectively, while situated on one of couches/chairs 114, 124, and 134, respectively. Each of the participants 113, 123, and 133 uses his or her remote control remote control 115, 125, and 135, respectively, to control a corresponding one of set-top boxes (STBs) 111, 121, and 131, respectively, which supply shared content to a corresponding one of the content monitors 112, 122, and 132, respectively, as described in applicants' co-pending applications (incorporated by reference herein).

The STBs 111, 121, and 131 all enjoy a connection to a communication channel 101, such as provided by a network content provider (e.g., a cable television provider or telecommunications carrier.). Alternatively, the communication channel 101 could comprise a link to a broadband network such as the Internet. The communication channel 101 allows the STBs receive content from a content source as well as to exchange information and video streams with each other, with or without intermediation by a server 103.

At each of the stations 110, 120 and 130, a corresponding one of the STBs 111, 121, and 131, respectively, receives a video signal from its corresponding one of telepresence cameras 117, 127, and 137, respectively. Each of the telepresence cameras 117, 127, and 137 serves to capture the image of a corresponding one of the participants 113, 123 and 133, respectively. As discussed in applicants' co-pending applications, each STB sends the video signals embodying telepresence images captured by its corresponding telepresence camera to the other STBs with or without any intermediate processing. Each STB receiving telepresence images from the STBs at the remote stations will supply the images for display on a display device at the local telepresence station. Some local telepresence stations, for example stations 120 and 130, include telepresence monitors 126 and 136, respectively, for displaying telepresence images of remote participants. At the stations 120 and 130, the telepresence monitors 126 and 136, respectively, support the telepresence cameras 127 and 137, respectively, so the telepresence cameras and monitors are co-located. The station 110 has no telepresence monitor and thus the STB 111 will display telepresence images of remote participants on the shared content monitor 112, which serves to support the telepresence camera 117.

As used herein throughout, “orientation” concerns the relative placement at a station (e.g., 120) of the shared content monitor (e.g., 122) and the telepresence camera (e.g., 127), with respect to the participant (e.g., 123) or equivalently, the participant's seat, (e.g., chair 124). At station 120, from the vantage of participant 123, camera 127 is rightward of shared monitor 122, which can be called a “right” orientation (whereas station 130 has a “left” orientation). While in normal use, the “orientation” of the equipment at a station does not change. This should not be confused with the “facing” of a participant, which is more dynamic. At station 120, participant 123 has facing 128 when watching shared content monitor 122, and facing 129 when looking at telepresence monitor 126 and thereby looking toward camera 127. With the “right” orientation of station 120, an image captured by camera 127 while participant 123 is looking at shared content monitor 122 (i.e., has facing 128) will show the participant facing to the right. In the case of station 110, the triangle formed by the participant, camera, and shared content monitor is collapsed, since the camera and shared content monitor is collapsed, in which case the station is said to have a “centered” orientation. In some contexts below, a participant “is facing” when the participant is looking toward the camera, and “is non-facing” when not looking toward the camera. Herein, to say the “orientation of a participant” or “participant having an orientation”, means a participant at a station having the orientation. [[<<-important because we have a lot of claims using this turn of phrase]]

While the participants 113, 123, and 133 watch their shared content monitors 112, 122, and 132, respectively, the participants will have a particular facing relative to their corresponding shared content monitors, indicated by the arrows 118, 128, and 138, respectively. However, when the participants 123 and 133 at the stations 120 and 130, respectively, watch their telepresence monitors 126 and 136, respectively, thereby looking toward the co-located telepresence cameras 127 and 137, respectively, the participants 123 and 133 will have facings 129 and 139, respectively.

At some telepresence stations, the telepresence monitor and telepresence camera can lie to the left of the shared content monitor as at the station 130. At other telepresence stations, the telepresence monitor and telepresence camera can lie to the right, such as at station 120. In case of the station 110, which has no separate telepresence monitor, the telepresence camera 117 lies co-located with the shared content monitor 112 and the telepresence images of the remote participants 123 and 133 will appear on that shared content monitor. As described in applicants' co-pending applications (incorporated by reference herein), the STBs can exchange information about the stations' orientations, or interact by assuming a predetermined orientation (e.g., providing and handling telepresence video signals to appear as if they originated from telepresence cameras on disposed to a particular side of the shared content monitor, e.g., to a participant's right when the participant faces his or her shared content monitor). An embodiment relying on an assumed orientation supports the interaction of this invention without the need to exchange orientation information.

The content supplied to each STB for sharing among the telepresence stations 110, 120 and 130 could originate from a broadcast station, or could comprise stored content distributed from a head end 102 by a server 103. The server 103 can access a database 104 storing containing television programs and a database 105 storing advertisements based on subscription or other access control or access tracking information stored in database 106. Note that the television programs and advertisements could reside in a single database rather than the separate databases as described. The server 103 can provide other services. For example, in some embodiments, the server 103 could provide the services necessary for setting up a telepresence session, or for inviting participants to join a session. In some embodiments, the server 103 could provide processing assistance (e.g., face detection, as discussed below).

Note that while discussion of the present principles refers to the illustrated embodiment of FIG. 1, which relies on STBs at each station, the embodiment of FIG. 1 merely serves as an example, and not by way of limitation. Implementation of the present principles can occur using inhomogeneous equipment at any station, which may include a dedicated telepresence appliance not associated with the shared content display, a desktop-, laptop-, or tablet computer, or a smart phone, as long as such equipment provides the functions of the telepresence camera, telepresence display, communications connection, and image processing, all discussed below.

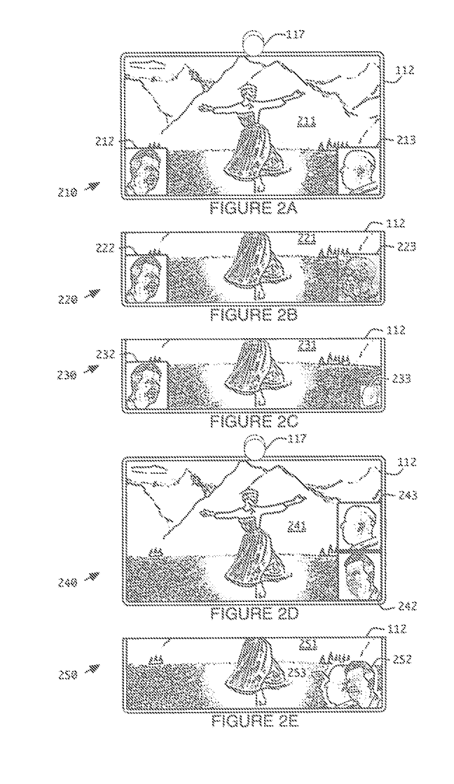

FIG. 2A depicts an exemplary presentation 210 of telepresence images 212 and 213 displayed to the participant 113 at the telepresence station 110 of FIG. 1 overlaid onto shared content in a common window on the shared content monitor 112. The composite image 211 displayed on the monitor 112 of FIG. 1 depicts shared content that is playing out substantially simultaneously (within a second or so, ideally within a frame or two) on the other shared content monitors 122, and 132 of FIG. 1. As seen in FIG. 2A, the images 212 and 213 of the remote participants 123 and 133, respectively, overlay the shared content displayed on the shared content monitor 112. The image 212 depicts the participant 123 as turned toward his or her corresponding telepresence camera 127 and thus appears turned toward the participant 113 of FIG. 1 watching the monitor 112 of FIG. 2A. The image 213 depicts the participant 133 facing his or her corresponding shared content monitor 132 of FIG. 1. Thus, the corresponding telepresence camera 137 at station 130 of FIG. 1 captures the participant 133 of FIG. 1 in profile.

In the illustrated embodiment, the STB 111 of FIG. 1 places the image 212 of FIG. 2A to the left side of the composite image 211. The STB 111 does so in accordance with its telepresence control functions, taking into account that the telepresence camera 127 lies to the right of participant 123 of FIG. 1 as he or she faces his or her corresponding shared content monitor 122. Similarly, the STB 111 manages the placement of the image 213 on the right side of the composite image 212 of FIG. 2A. The STB 111 does so in accordance with the telepresence control functions provided by that STB, taking into account that the telepresence camera 137 of FIG. 1 lies to the left of the participant 133 as he faces his or her corresponding shared content monitor 132.

FIG. 2B depicts an exemplary presentation 220 of the telepresence images 222 and 223 of the remote participants 123 and 133, respectively, (all of FIG. 1) overlaying the shared content to produce the composite image 221 displayed on the shared content monitor 112. In this case, the telepresence system 100 of FIG. 1 uses face detection and pose estimation to determine that the remote participant 133 does not face his or her telepresence camera 137 of FIG. 1. Face detection and pose estimation algorithms exist in the art, for example, as taught by Miller, et al. in U.S. Pat. No. 7,236,615 and can discern the presence of a face in an image, and the angle of that face relative to the camera which can be used instantaneously to determine facing (i.e., whether the participant is facing the camera, or is not facing the camera), and used over time to automatically identify orientation, as indicated by the direction of the most commonly observed angle of that face when the participant is not facing the camera, that is, the “dominant facing”. Such face detection and pose estimation could occur at the receiving STB (e.g., STB 111), the sending STB (e.g., STB 131), or at the remote server 103, or at any combination of these devices.

Depending on the remote participant's pose, the remote participant's image will appear as transparent or opaque when processed by either the sending or receiving STB, with or without assistance of the remote server 103. Assume that a remote participant (e.g., participant 133) has a non-facing pose (e.g., looking in the direction 138, so as not facing the corresponding telepresence camera 137), as determined by the face detection and pose estimation algorithm. Under such circumstances, the corresponding participant image 223 becomes at least partially transparent to minimize the impact on the shared content in composite image 221. However, when a remote participant (e.g., 123) has a facing pose (e.g., looking in direction 129 toward corresponding camera 127), then the corresponding participant image 222 becomes substantially opaque.

The exemplary presentation 230 shown in FIG. 2C appears similar to that shown in FIG. 2B, but instead of varying the transparency, the STB could vary the size of the remote participant images 232 and 233 relative to the shared content in the composite image 231. When the remote participant has a non-facing pose (as does the participant 133), the STB will reduce the size of the corresponding participant image 233. However, but when the participant has a facing pose (as is 123), the STB will increase the size of the corresponding participant image 232. In other embodiments (not shown), the decreased opacity and reduced size effects applied in FIGS. 2B and 2C, respectively, to non-facing participant images could be combined, so that non-facing participant images have a smaller size and greater transparency.

FIG. 2D depicts another exemplary presentation 240 of telepresence images of remote participants overlaid onto shared content in a common window, wherein both remote participant images 242 and 243 lie to one side of the shared content appearing in the composite image 241. However, to support the impression that the remote participants watch the same shared content, the STB can horizontally flip the remote participant's telepresence image (as indicated in the image 242) relative to the image captured by the corresponding telepresence camera 127 of FIG. 1. In this example, with the telepresence camera 127 of FIG. 1 lying to the right of the corresponding participant 123 of FIG. 1 (i.e., where station 120 has a “right” orientation), the camera image, if not manipulated, would show the participant 123 generally facing to the right (as depicted by the images 212, 222, and 232). Instead, the STB 111 will display the flipped image 242, which depicts the remote participant 123 as generally facing to the left.

In some embodiments, presentation of windowed images such as images 242 and 243 could occur by presenting such images completely outside of the shared content so that they appear in independent windows (rather than being composited into the single image 241). Presenting these images in this manner suffers from the disadvantage that the shared content will appear smaller than it might otherwise appear, depending upon the aspect ratio of the shared content and that of the shared content monitor 112.

In other embodiments, the presentation technique of FIG. 2D can be combined with the other techniques that vary the image size and transparency, to produce the composite image.

FIG. 2E depicts an exemplary presentation 250 of telepresence images of remote participants tiered and overlaid onto the shared content in a common window. The presentation 250 of FIG. 2E represents a variation of the presentation 240 of FIG. 2D, which allocates distinct windows to each of the remote participant image 242 and 243. In contrast, the presentation 250 of FIG. 2E has the remote participant images overlapping each other while the background portions of the participant images appear transparent, thereby producing the tiered presentation, as illustrated by the images 252 and 253 overlaid onto the shared content in the composite image 251. This has the advantage of consuming less screen space and obscuring a smaller portion of shared content, as compared to other presentations using similarly sized participant images. However, this approach requires additional computation to separate the image of each participant from the background captured by the corresponding telepresence camera. In other embodiments, this presentation could find application, in combination with the other techniques that vary the image size and transparency, to produce the composite image.

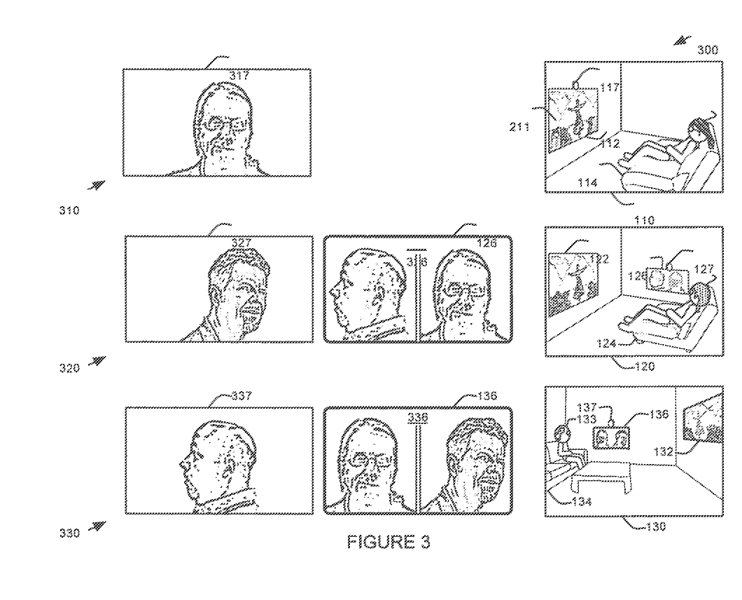

FIG. 3 depicts an aggregate situation 300 for the telepresence system 100, depicting situations 310, 320 and 330 occurring at the stations 110, 120, and 130 respectively The situations 310, 210 and 330 of FIG. 1 depict exemplary local telepresence camera images and remote telepresence monitor images associated with a separate one of the telepresence stations during its operation. At each station, the shared content plays out in substantial synchronization on the shared content monitors 112, 122, and 132. Participants 113, 123, and 133 sit on chairs or couches 114, 124, and 134, respectively, generally facing their respective shared content monitors (i.e., holding facings 118, 128, 138). Participants 123 and 133 also have their telepresence monitors 126 and 136, respectively, available for viewing. At station 110, the telepresence camera 117 lies co-located with the shared content monitor 112, while at stations 120 and 130, the telepresence cameras 127 and 137 lie to one side of their corresponding shared content monitor 122, and 132, respectively, and lie co-located with a corresponding one of the telepresence monitors 126 and 136, respectively. Thus, the telepresence camera 117 directly faces the participant 113 to produce frontal view 317, due to the “center” orientation of station 110. In contrast, the telepresence cameras 127 and 137 generally capture their corresponding participants 123 and 133, respectively, from the side to produce profile views 327 and 337, respectively (due to their “right” and “left” orientations, respectively). However, if a participant turns to face his or her local telepresence monitor (as depicted by the participant 123 facing his telepresence monitor 126), the resulting telepresence image 327 has the participant facing the telepresence camera. However, the telepresence image 327 still suggests a profile view, and does not constitute a frontal view.

At the station 110, a composite image 211 appears on the shared content monitor 112. (In other exemplary embodiments, the image 211 could look like the composite images 221, 231, 241, or 251.) At the other stations 120 and 130 having independent telepresence monitors 126 and 136, respectively, these telepresence monitors display the telepresence images 326 and 336 of their respective remote participants. Depending on the orientation of the corresponding remote telepresence stations, the individual images of the remote participants in the composite images 326 and 327 may require horizontal flipping to support the illusion that the remote participants face their local shared content monitor 126 and 136, respectively. (In the illustrative embodiment, such image flipping remains unnecessary.). Note that no need exists to flip the frontal image 317 when displayed on either of the remote telepresence monitors, since participant directly faces the telepresence camera. In contrast, the images 327 and 337, typically do not constitute frontal images, which generally do not arise from the participants facing their respective telepresence cameras, although, as shown in image 327, they can occasional constitute a “facing” image.

For the exemplary situation 300 of FIG. 3, but where composite image 251 is shown on monitor 112 (instead of composite image 211 as shown), the STB 111 must obtain each remote participant's head isolated from the background in the images 327 and 337 in order to display the composite image 251 (instead of the image 211 as shown). A number of image processing techniques for separating an object from a static background readily exist, as surveyed by Cheung, et. al, in Robust techniques for background subtraction in urban traffic video, Proceedings of Electronic Imaging: Visual Communications and Image Processing, 2004, WA:SPIE. (5308):881-892. Using such image isolation techniques applied to the participants' heads, the STB 111 of FIG. 1 could readily produce the image 251 by compositing such isolated remote participant images with the shared content. Alternatively, the isolation of the heads from the backgrounds can be performed by the respective source STBs 121 and 131, or by a server (e.g., 103).

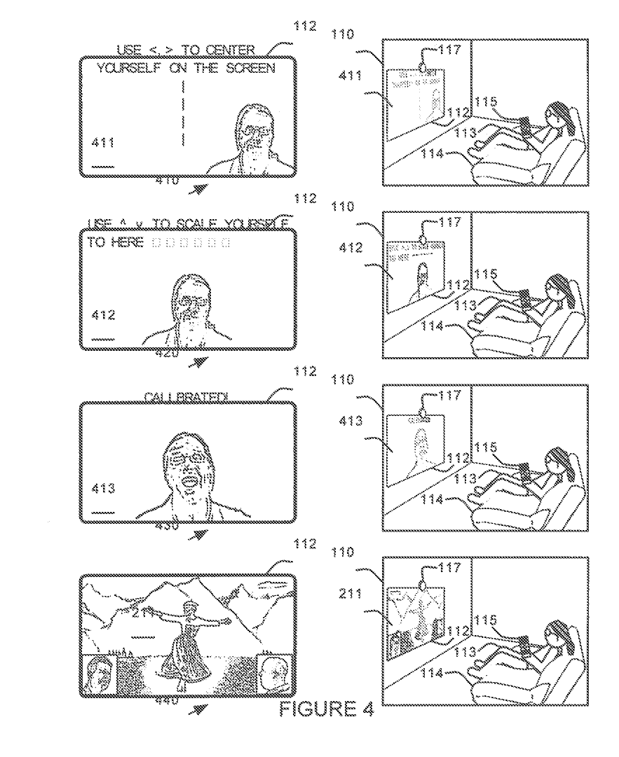

FIG. 4 depicts a calibration sequence 400 for the devices at each telepresence station, such as station 110 of FIG. 1. The calibration sequence commences upon execution of step 410 during which the STB 111 of FIG. 1 causes the shared content monitor 112 of FIG. 1 to display a calibration image 411 derived from the image obtained by local telepresence camera 117. Along with the calibration image 411, the shared content monitor 112 will also display instructions to the participant 113, directing him or her to use specific controls on the remote control 115 to center the participant's own image (as obtained from the local telepresence camera 117) on the shared content monitor 112 of FIG. 1. The centering can occur via a mechanical or electronic pan of the telepresence camera 117.

During step 420, the STB 111 of FIG. 1 generates a second calibration image 412 for display on the shared content monitor 112 of FIG. 1 to instruct the participant 113 to use specific controls on his or her remote control 115 to scale the participant's image displayed on the shared content monitor. Once the participant has completed image centering and scaling, then during step 430, the STB 111 will generate a message (shown in image 413) for display on the shared content monitor 112 to alert the participant 113 that he or she has completed calibration. Thereafter, during step 440, the STB 111 causes the shared content monitor 112 to display a composite image (e.g., image 211) comprising shared content and remote participant's telepresence images. In an alternative embodiment, the calibration can be conducted automatically, and may be continuously updated. In some embodiments, the scaling can be performed by an optical zoom in the telepresence camera 117.

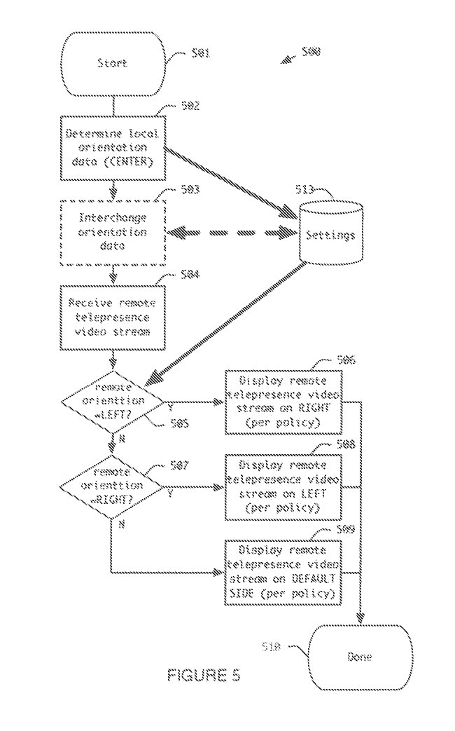

FIG. 5 depicts, in flowchart form, the steps of an exemplary process 500 for execution by the STB 111 (or other device at the station 110) to process the remote telepresence images from each remote station 120, 130. As described in detail hereinafter, the process 500, when executed, enables the STB 111 or other device to determine a placement for each of the remote telepresence images, e.g., to determine on which of the two sides of the composite image 211 each will be displayed. The process 500 commences upon execution of step 501 during which the STB 111 connects to the remote STBs (e.g., STBs 121 and 131) at the other participating telepresence stations through which the corresponding participants 113, 123 and 133 can view shared content. During step 502, the STB 111 will determine the spatial relationship, i.e., ‘orientation data’ indicative of the orientation of the telepresence camera 117 to the shared content monitor 112. Since the telepresence camera 117 lies co-located with and has an optical axis substantially in parallel with that of the shared content monitor 112 at station 110, this station has a ‘CENTER’ orientation because the telepresence camera 117 captures a frontal image (e.g., image 317) of the local participant 113. This orientation data may have been predetermined (e.g., the local equipment has only one possible or allowed configuration). In the absence of such predetermined information, the STB 111 can automatically detect such a condition by sensing the absence of a separate telepresence monitor. Alternatively, the STB could detect this condition through an interaction with the local participant. Regardless of how derived, the STB 111 will record this orientation information in a settings database 513.

In one exemplary embodiment, the STB 111 can transmit the orientation information (e.g., telepresence station configuration) stored in the settings 513 database to the other participating stations during a configuration step 503 whose execution is optional. Sending the station configuration constitutes one approach to enable a remote station to correctly handle placement and if necessary, the horizontal flipping of a remote participant image. Alternatively, the telepresence video signal sent to each remote station can include embedded orientation information, typically in the form of metadata so the interchange of orientation data occurs concurrently with the interchange of telepresence video signals.

In other embodiments, no need exists to exchange orientation information if all the stations adhere to a convention that assumes a predetermined orientation. This approach has particular application to those embodiments that gather all remote telepresence images to one side or the other as in depicted composite images 241 and 251, but is also more generally applicable. For example, the convention could dictate that all sending STBs provide telepresence images in a particular orientation, for example ‘LEFT’. In other words, the sending STB will pretend that its associated telepresence camera lies to the left of the shared content monitor, whether or not this is actually the case. It actually is the case with the station 130, where telepresence monitor 136 and camera 137 lie to the left of the participant's shared content monitor 132). This corresponds to remote participant images having a generally left-facing profile (i.e., their nose most-often points leftward, from the camera's perspective). Since the station 120 has a “RIGHT” orientation, applying the above-identified convention would dictate that the telepresence image of the participant 123 provided by the station 120 of FIG. 1 undergo a horizontal flip. In this way, the telepresence image will have a generally left-facing profile, as if camera 127 were located on the opposite side. As a result of applying a horizontal flip to a participant's telepresence image, the resulting display depicts a mirror image of the affected participant, which usually does not produce terribly objectionable results.

During step 502 of FIG. 5, the STB at a given station, such as STB 111 at station 110 of FIG. 1, will determine the orientation (i.e., telepresence camera orientation relative to the shared content monitor). Taking into account the convention discussed above, the STB 111 at station 110 will determine during step 502 that it has a ‘CENTER’ orientation. Thus, under such circumstances, the STB 111 need not flip its telepresence image since the telepresence image has no left- or right-orientation that requires image flipping: Rather, the telepresence image provided by the telepresence camera 117 at station 110 of FIG. 1 depicts a frontal view of the participant 113 and thus requires no horizontal flip.

In some embodiments, the participant can select the mode of display of his or telepresence images (e.g., images 211, 221, 231, 241, 251, or others) as a participant preference.

In some instances, exchange of orientation information among stations can prove useful, as indicated by optional nature of step 503 during which exchange of such orientation information would occur. This can be true even when the orientation convention discussed above is in use: For example, telepresence images from participants having a ‘CENTER’ orientation (as shown in 317) can be arranged to be ‘behind’ telepresence images from participants having a non-CENTER orientation (as do images 327, 337), a seen in composite telepresence images 326, 336, which provides a more aesthetic composition than if the image positions were swapped, which would appear to have one participant staring at the other (e.g., in image 326, if the head positions were swapped, participant 133 would appear to be looking at participant 113).

During step 504, telepresence images from another station are received by the STB 111. During step 505, the receiving STB (e.g., STB 111) determines whether the received telepresence image is from a left-oriented configuration. This determination is based on the configuration stored in settings 513. If so, the STB 111 will apply a prescribed policy during step 506, for example to exhibit the received telepresence images of that remote participant on the right side of the composite image displayed on the shared content monitor 112 of FIG. 1. As depicted in FIGS. 2A-2E, the telepresence images 213, 223, 233, 243, and 253 from left-oriented station 130 all appear on the right side of the composite image displayed on the shared content monitor 112 of FIG. 1.

If the received telepresence image is not from a left-oriented station when evaluated during step 505, then STB undertakes an evaluation during step 507 to determine whether the image is from a right-oriented configuration, again based on the configuration stored in settings 513. If so, the STB 111 will apply the prescribed policy during step 508 to display that remote participant image on the left side of the composite image displayed on the shared content monitor 112. As depicted in FIGS. 2A-2C, the remote participant images 212, 222, and 232 from right-oriented station 120 all appear on the left side of the composite image displayed on the shared content monitor 112 of FIG. 1

If the received remote telepresence image is not from a left or right oriented station (i.e., the remote station has a ‘center’ orientation) when evaluated during steps 505 and 507, respectively, then STB 111 executes step 509 to identify a default placement for the remote participant image on monitor 112 in accordance with a prescribed policy. For example, step 509 undergoes execution upon receipt of a telepresence image from a remote station with a center orientation, such as station 110, which has its telepresence camera co-located with the shared content monitor.

In an alternative embodiment operating with different policies, some remote telepresence images could undergo a horizontal flip during step 508, corresponding to the flipping of the telepresence images 242 and 252 prior to display on the right side of the composite image.

In other embodiments, the policy applied during the execution step 506, 508, and 509 could consider participant preferences. For example, the telepresence system 100 could apply a policy that prescribes consecutive allocation of on-screen position to the telepresence images of remote participants. For example, at each local station, the STB could allocate a first position in the composite image displayed by the shared content monitor 112 to a first-joined station (e.g., the station that joined the telepresence session first), with subsequent positions allocated to the telepresence images from successively joining stations. In some embodiments, user preferences could identify particular placements for telepresence images of particular participants. For example, a participant at a given station could preferentially assign a particular position (e.g., the bottom right-hand screen corner) to that participant's best friend when that best friend participates in the current telepresence session.

After determining placement of each telepresence image during step 506, 508, or 509, the process ends during step 510.

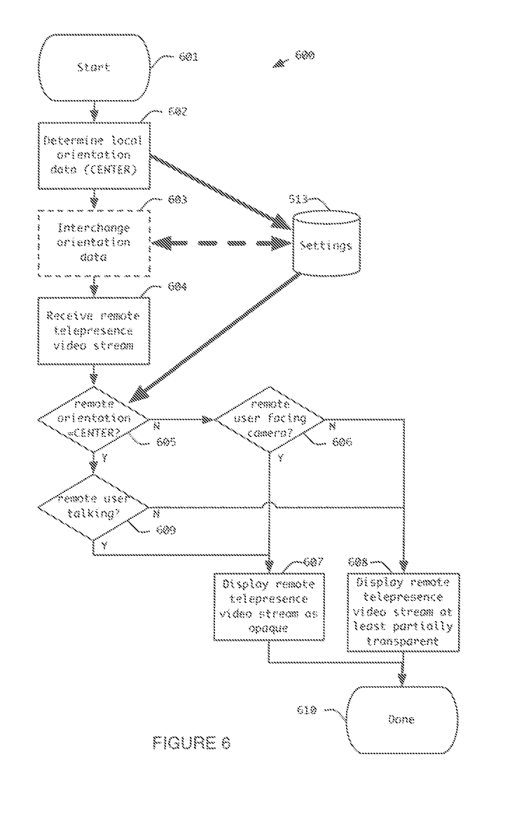

FIG. 6 depicts in flowchart form the steps of a process 600 for dynamically modifying the presentation of telepresence images of remote participants (e.g., images 222, and 223). Steps 601, 602, 603, and 604 in FIG. 6 correspond to the steps 501, 502, 503, 504, respectively, in FIG. 5 so for a complete description of such steps, refer to FIG. 5. Following step 604 of FIG. 6, step 605 undergoes execution during which time the receiving STB undertakes determines if the received telepresence image is from a station with a ‘CENTER’ orientation. If not, then step 606 undergoes execution at which time the receiving STB determines whether the remote participant substantially faces his or her telepresence camera. Typically, the receiving STB makes this determination using face detection software, though in some embodiments, each remote STB can use face detection software on the image from the corresponding telepresence camera, and transmit the results of that detection as metadata accompanying the image when sent, thereby reducing step 606 to a mere examination of the metadata to determine whether a remote user is facing the corresponding camera. This latter implementation has the advantage of reducing the computation at each station, since face detection need be run on only one image (the outbound one) rather than on each incoming image.

Upon determining that the remote participant faces his or her telepresence camera during step 606, then the STB will make the received telepresence image opaque during step 607, as depicted by telepresence image 222 in FIG. 2B. Otherwise, upon determining that the remote participant does not face his or her telepresence camera during step 606, then the STB will make the received telepresence image at least partially transparent during step 608, as depicted by telepresence image 223 in FIG. 2B.

If, during step 605, the STB determines that the received telepresence image is from a station with a “CENTER” orientation, then any subsequent determination of whether the remote participant faces his or her telepresence camera in order to control the telepresence image visibility will not prove useful: A remote telepresence image from a “CENTER” oriented station results in a remote participant directly facing his or her telepresence camera almost constantly (e.g., participant 113 will usually have facing 118). Instead, it is the activity of a remote participant at a station with a “CENTER” orientation that constitutes a more useful indicator for controlling the visibility of that participant's image when displayed in connection with the composite image appearing on the shared content monitor. For this reason, during step 609, the receiving STB will determine whether that remote participant is talking. The STB could use either audio-based techniques (i.e., speech determination) or video-based techniques (i.e., a lip movement determination) for this purpose. If the STB determines the remote participant to be talking, then the STB will display that remote participant's telepresence image as more opaque during step 607. Otherwise, the STB will display that remote participant's telepresence image as more transparent during step 608.

When the system is used by individuals who use sign language, the determination at step 609 could also include detection of gestures likely to represent sign language communication, or simply using hand detection at step 609, much as face detection is used in step 606. Hand detection in video is well-known in the art, as taught by Ciaramello and Hemami of Cornell University in “Real-Time Face and Hand Detection for Videoconferencing on a Mobile Device”, as published in the Fourth International Workshop on Video Processing and Quality Metrics for Consumer Electronics (VPQM), Scottsdale, Ariz., January 2009.

Although not shown in FIG. 6, the process 600 could include various modifications. For example, in some circumstances, dynamic scaling of the telepresence images 232 and 233 prior to incorporation in the composite image (e.g., the composite image 231) may be desired. Under such circumstances, the STB could increase the scale of the telepresence images of remote participants during 607 or decrease their scale during step 608. In other embodiments of the process 600, the choice between making the remote participant's telepresence image opaque during step 607 or transparent during 608 could depend entirely on whether the remote participant is talking as determined at step 609, thereby obviating the need for steps 605 and 606. Alternatively, the decision to make the remote participant's telepresence image opaque during step 607 might require both facing the camera and talking, and a lack of either would result making the image transparent during step 608. This is useful if participants tend to hold unrelated conversations with people elsewhere in their room, and are not facing their corresponding telepresence camera when doing so. As previously mentioned, steps 607 and 608 can modify both the opacity and size of the remote participant's telepresence image depending on whether a remote participant faces his or her telepresence camera or whether the participant is talking.

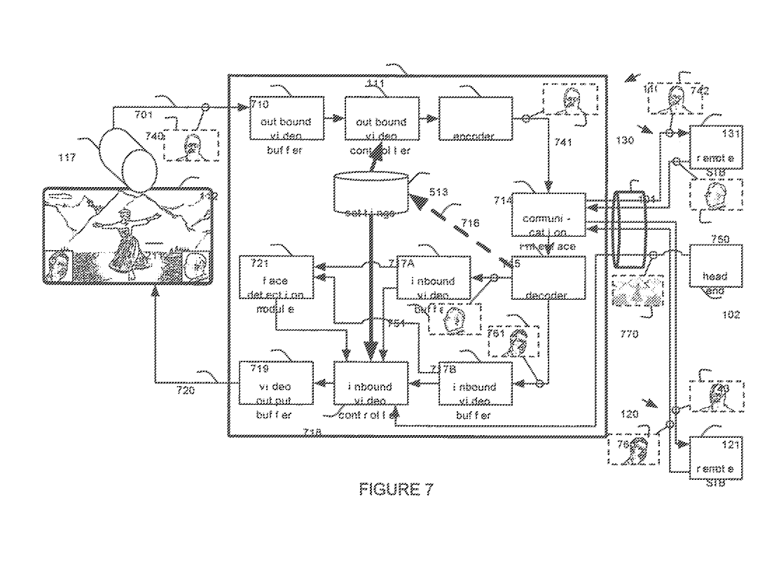

FIG. 7 depicts block diagram of an STB within the telepresence system 100 of FIG. 1 as exemplified by the STB 111. The STB 111 has an interface 701 that receives a video signal 740 from the telepresence camera 117 of FIG. 1 embodying the telepresence image of the local participant 113. An outbound video buffer 710 in the STB 111 stores the telepresence image for access and subsequent manipulation by an outbound video controller 711. An encoder 712 encodes the telepresence image from the outbound video controller 711 in accordance with data from the settings database 513 of FIG. 5. For example, in embodiments where orientation information interchange occurs by incorporating orientation data into the video stream, the encoder 712 will encode orientation data from the setting database 513 as metadata into the resulting telepresence video signal 741. Additionally, the video buffer 710 can store calibration information, for example as obtained and recorded during the calibration process 400 of FIG. 4. The encoder 712 can use the calibration data to set cropping and scaling of the telepresence image received from the outbound video buffer 710.

In an embodiment where the telepresence image undergoes horizontal flipping, when necessary, so as to resemble a particular conventional orientation, then an indication in the settings database 513 for a ‘CENTER’ orientation (as might be recorded during step 502) or the orientation prescribed by the convention, would indicate no flipping required, whereas an indication of the opposite orientation would require horizontally flipping the image. The horizontal flip of the outbound image, when needed, can be performed by outbound video controller 711.

The STB 111 provides its outbound telepresence video signal 741 via communication interface 714 to the communication channel 101 to transmission each of the remote STBs 121, 131 at the remote telepresence stations 120 and 130, respectively, as video signals 743 and 742, respectively. In return, the stations 130 and 120 send their outbound telepresence video signals 750 and 760, respectively, through the communication channel 101 for receipt by the STB 111 at its communication interface 714, which passes the signals to a decoder 715. In embodiments where orientation data undergoes exchange during step 503 of FIG. 5 or the orientation data is encoded into the telepresence video signals 750, 760, the decoder 715 will transmit that orientation data via a channel 716 to be recorded in the settings database 513.

The decoder 715 processes the inbound telepresence video signals 750 and 760 to provide a sequence of images 751 and 761 to corresponding inbound video buffer 717A and 717B, respectively. A face detection module 721 analyzes the images in the inbound video buffers 717A and 717B to determine whether the corresponding remote participants 133, 123 have turned toward their respective telepresence cameras 137 and 127. In some embodiments, detection module 721 may also detect for the presence of hands (e.g., as a detection of sign language), or may analyze the audio streams (not separately shown) corresponding to the image streams 751 and 761 to detect for talking, as discussed above.

An inbound video controller 718 receives shared content 770, for example as provided from head end 102. For simplicity of explanation, FIG. 7 does not depict the details associated with decoding and buffering of the shared content signal 770 as might be needed to facilitate synchronization of the shared content at each of the remote stations. However, decoding and buffering incoming content and synchronization remains well known in the art. For those embodiments (not shown), where the shared content signal comprises an over-the-air broadcast or comprises content provided by any of STBs 111, 121, and 131, head end 102 may still supply content 770, but other than through channel 101. Either way, the inbound video controller 718 will still receive all incoming content regardless of its source.

The inbound video controller 718 composites the shared content 770 with the remote participant's telepresence images stored in inbound video buffers 717A and 717B. The composition performed by the inbound video controller 718 takes account of the orientation information stored in the settings 513 database and the results from detection module 721 to determine position and scale and/or opacity as discussed with respect to processes 500 and 600, and their variants. The inbound video controller 718 writes the resulting composite image to a video output buffer 719, which provides a video signal 720 to shared content display 112, for display, in this example as composite image 211.

The foregoing describes a technique for enabling a telepresence station having a single monitor to provide an improved experience when showing both shared content and telepresence streams of one or more remote participants whose telepresence cameras do not lie close to their shared content monitor.

1. A method for managing images of remote participants at remote telepresence stations displayed to a local participant at a local telepresence station in a telepresence system, comprising the steps of:
establishing orientations for remote participants relative to respective image capture devices; and
processing remote participants' images for display to the local participant in accordance with the established orientations to control at least one of horizontal image flip and image location within a display.

2. The method according to claim 1 wherein the step of establishing orientations includes receiving orientation information from the remote telepresence stations indicative of the orientation at each station.

3. The method according to claim 1 wherein the step of establishing orientations is on the basis of a predetermined convention.

4. The method according to claim 1 wherein the step of establishing orientations includes step of evaluating the received remote participants' images at the local telepresence station to determine each remote participants' dominant facing.

5. The method according to claim 4 wherein the step of evaluating the remote participants' images at the local telepresence station includes detecting each remote participant's face.

6. The method according to claim 1 wherein the step of processing received remote participants' images for display includes the step of compositing an image of shared content with the received remote participants' images to yield a combined image for display.

7. The method according to claim 1 wherein the step of processing received remote participants' images for display includes the step of locating at least one of the participants' images on a first side of a display of such images when the participant associated with the at least one image has a first orientation.

8. The method according to claim 1 wherein the step of processing received remote participants' images for display includes the step of locating at least one other of the participants' images on a second side of a display of such images when the participant associated with the at least one other image has a second orientation.

9. The method according to claim 1 wherein the step of processing received remote participants' images for display includes the step of locating at least one of the remote participants' images on a side of a display, the side selected in accordance with a user command.

10. The method according to claim 1 wherein the step of processing received remote participants' images for display includes the step of rendering at least one of the participants' images substantially opaque in a display of such images when the participant associated with the at least one image has a first facing.

11. The method according to claim 1 wherein the processing received remote participants' images for display includes the step of rendering at least one other of the participants' images substantially transparent in a display of such images when the participant associated with the at least one other image has a second facing.

12. The method according to claim 1 wherein the step of processing received remote participants' images for display comprises rendering a first and second ones of the participants' images such that the first participant image is larger than the second participant image on the basis of the first participant being facing in the first image and the second participant being non-facing in the second image.

13. The method according to claim 5 wherein the processing received remote participants' images for display includes the step of locating at least one of the participants' images on a first side of the combined image for display when the participant associated with the at least one image has a first orientation.

14. The method according to claim 1 wherein the processing received remote participants' images for display includes the step of locating at least one other of the participants' images on a second side of the combined image for display when the participant associated with the at least one other image has a second orientation.

15. The method according to claim 1 wherein the processing received remote participants' images for display includes the step of locating at least one of the remote participants' images on a selected side of the combined image for display in accordance with a user command.

16. The method according to claim 1 wherein the processing received remote participants' images for display includes the step of rendering at least one of the participants' images substantially opaque in the combined image for display when the participant associated with the at least one image has a first orientation.

17. The method according to claim 1 wherein the processing received remote participants' images for display includes the step of rendering at least one other of the participants' images substantially transparent in the combined image for display when the participant associated with the at least one other image has a second orientation.

18. Apparatus for use in a telepresence system, comprising:
an input buffer for receiving images of a plurality of participants, each at a plurality of remote stations;
video processing means coupled to the input buffer for receiving information of orientations for each of remote telepresence system participants relative to their respective image capture devices; and processing received remote participants' images to yield an output image in accordance with the established orientations to control at least one of image visibility and image location within a display; and
an output buffer coupled to the video processing means for supplying the output image from the video processing means to a display device.

19. The apparatus according to claim 18 wherein the video processing means composites an image of shared content with the received remote participants' images to yield the output image.

20. The apparatus according to claim 18 wherein the video processing means locates at least one of the participants' images on a first side of a display of such images when the participant associated with the at least one image has a first orientation.

21. The apparatus according to claim 18 wherein the video processing means locates at least another one of the participants' images on a second side of a display of such images when the participant associated with the at least one other image has a second orientation.

22. The apparatus according to claim 18 wherein the video processing means locates at least one the remote participants' images on a side of a display of such images selected in accordance with a user command.

23. The apparatus according to claim 18 wherein the video processing means of renders substantially opaque at least one of the participants' images the output image when the participant associated with the at least one image has a first orientation.

24. The apparatus according to claim 18 wherein the video processing means of renders substantially transparent at least one other of the participants' images the output image when the participant associated with the at least one other image has a second orientation.

25. The apparatus according to claim 18 wherein the video processing means provides orientation information of its local telepresence system to each remote telepresence system.
